(19) United States
(12) Patent Application Publication
(10) Pub. No.: US 2026/0340124 A1
(43) Pub. Date: Oct. 29, 2026

(54) DATA PROTECTION CONTENT SCANNING USING DISK EXTENTS

(71) Applicant: Dell Products L.P., Round Rock, TX (US)

(72) Inventors: Gerald M. Jourdain, Hudson, NH (US); Ravindra Lingampeth, Solapur (IN); Abinas Tewari, Charlotte, NC (US)

(21) Appl. No.: 19/188,666

(22) Filed: Apr. 24, 2025

(51) Int. Cl. G06F 21/56; G06F 11/1446

(52) U.S. Cl. CPC G06F 21/56; G06F 11/1451

(57) ABSTRACT

One example method includes receiving a first file catalog for a first backup, comparing a file list of the first file catalog with a file list of a subsequent file catalog for a second backup occurring after the first backup, based on the comparing, identifying as changed files, those files that have changed between the first backup and the second backup, receiving each changed file as a stream, scanning disk extents present in the stream, and based on the scanning, identifying content of interest in one or more of the changed files.

### COPYRIGHT AND MASK WORK NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### TECHNOLOGICAL FIELD OF THE DISCLOSURE

Embodiments disclosed herein generally relate to data protection and related processes. More particularly, at least some embodiments relate to systems, hardware, software, computer-readable media, and methods, for data protection content scanning using disk extents.

### BACKGROUND

Today many ransomware scanners scan the entire backup iterating over every file looking for infection. This iteration is a post data protection process and requires additional hardware and considerable resources. After implementing this process these ransomware scanners evolve to try and figure out what has changed from the previous backup so they can decrease their iteration time by only scanning the changes. These processes for detecting changes between backups are slow and do not support all backup workloads and, as such, constitute only a partial solution.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a schema, according to one example embodiment.

FIG. 2 discloses aspects of a backup comparison approach, according to one embodiment.

FIG. 3 discloses aspects of a content scanning approach, according to one embodiment.

FIG. 4 discloses an example computing entity configured and operable to perform any of the disclosed methods, processes, and operations.

### DETAILED DESCRIPTION OF SOME EXAMPLE EMBODIMENTS

Embodiments disclosed herein generally relate to data protection and related processes. More particularly, at least some embodiments relate to systems, hardware, software, computer-readable media, and methods for data protection content scanning using disk extents.

Example embodiments comprise a schema, method, and architecture, for scanning backed up data to identify content of interest. Such content of interest may include, but is not limited to, malware such as ransomware. Thus, some embodiments may operate to detect, in backed up data, file corruption, file encryption, and/or, file infection. As another example, content of interest that may be identified by an embodiment may comprise PII (personally identifiable information). Thus, the scope of this disclosure is not limited to the identification of ransomware and/or its effects.

A method according to one example embodiment may comprise various operations including, but not limited to: receiving a first file catalog for a first backup; comparing a file list of the first file catalog with a file list of a subsequent file catalog for a second backup; based on the comparing, identifying as changed files, those files that have changed between the first backup and the second backup; receiving each changed file as a stream; scanning disk extents present in the stream; and, based on the scanning, identifying content of interest. In an embodiment, a backup may be running in parallel with, but ahead of, this method.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that only blocks from those files that have changed between backups are read out and scanned. An embodiment may enable various different applications to read changed files in a streaming fashion notwithstanding that those changed files may have different respective extents. An embodiment may use file system catalogs, and their comparison to the previous backups catalog, to produce a list of only changed files, and by incorporating the disk extents for those files, an embodiment may perform targeted reads from the backup for interrogation. An embodiment may combine a file change list produced by a data protection indexing process with the disk extents for those files, and then traverse the file change list to read only those blocks from files that have changed. Various other advantages of one or more example embodiments will be apparent from this disclosure.

### A. Overview of aspects of an example embodiment

One or more embodiments may be directed to schemas, methods, and architectures for detecting document corruption, encryption or infection during a data protection process, which may comprise a full or incremental backup for example, but without materially impacting resource requirements for the data protection process. To this end, an embodiment may combine a file change list produced by the data protection indexing process with the disk extents for those files. By traversing this file change list, an embodiment may be able to read only those blocks from files that have changed.

That is, by incorporating file system catalogs and their comparison to the previous backups catalog, an embodiment may produce just a list of changed files, and by incorporating the disk extents for those files, an embodiment may perform targeted reads from the backup for interrogation. An asset or target to be backed up may have many files, potentially hundreds of millions of files, or more. The file change rate is typically small, in the range of less than 1%. By just analyzing the changed files and using their specific backup translated block numbers, an embodiment can reduce this content scanning task by well over an order of magnitude and in many cases approaching two orders of magnitude. An embodiment may be extended to include, for example, not only ransomware scanning, but many other complex content scanning processes such detecting PII (personally identifiable information), for example.

### B. Example architecture and method according to one embodiment

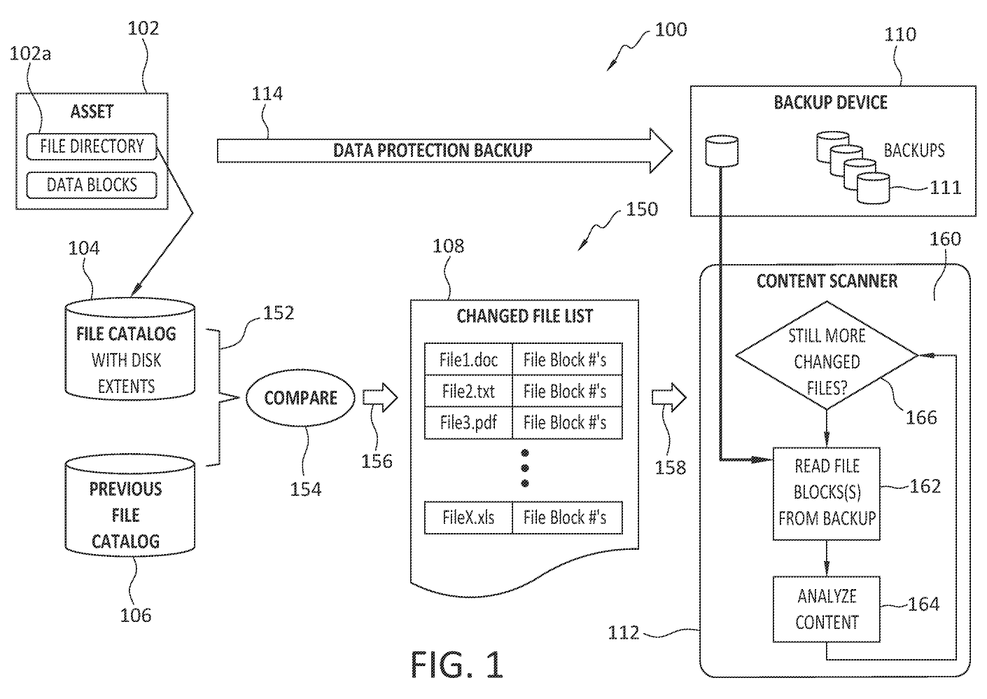

With attention now to FIG. 1, an example schema 100 according to one embodiment is disclosed. The elements of the example schema 100 include, but are not limited to, an asset 102 comprising files that are to be backed up, file catalogs 104 and 106 corresponding to respective backups of the asset 102, a changed file list 108 listing files that have changed from one backup to another, a backup device/system 110 that creates the backup(s) 111 of the asset 102, and a content scanner 112 that uses the changed file list 108 as a guide to scan the backup(s) 111 of the asset 102.

### B.1 Introduction

As shown in FIG. 1, a data protection, or backup, process 114 may be ongoing while a method according to an embodiment is performed. For example, the backup process 114 may begin prior to a method according to an embodiment, but for a period of time thereafter, a portion of the method according to an embodiment may be performed simultaneously with the backup process 114.

Most file systems have a data structure composed of a list of directories, as shown at 102a, and files contained within them. This is referred to as a Master File table (MFT), or iNode table, depending on the file system. This data structure will be referred to herein generically as the MFT. During the data protection process 114, the file system type is detected and then the MFT is read from the asset. Different file systems have different directory structures. This process may be quite complicated and may involve support for many different file systems, like NTFS, EXT2-4, XFS, BtrFS, and FAT for example.

A file system catalog is a normalized list of files, and their attributes referred to as file metadata. This normalized file list decouples the individual file system specifics. Each directory entry has common pieces of metadata across file systems like filename, location (file path), creation date, and modification date, for example. In addition to these common metadata fields, each directory entry contains a file location. Often this file location is expressed as what is sometimes referred to as a disk extent.

A disk extent is defined as a contiguous chunk on a disk with a starting and ending block number. A file, when created, is assigned a disk extent. If the file grows in size, then a separate chunk of disk, disk extent, is assigned to it. In some cases, the file system represents file location in other ways, but they can be normalized into a disk extent representation.

With continued reference to FIG. 1, and as discussed in further detail below, an example method 150 according to one embodiment may begin by obtaining 152 the previous file catalog 106, that is, the file catalog for the backup preceding the backup 114 currently in progress. As well, the file catalog 104, with disk extents for the associated files, for the ongoing, or completed, subsequent backup 114 may be obtained 152.

Next, a comparison 154 may be performed of the two file catalogs 104 and 106, and the files that have changed between the two backups identified. As a result of the comparison 154, the changed file list 108 may be generated 156.

The changed file list 108 may then be input 158 to the content scanner 112. The content scanner 112 may use the changed file list 108, which comprises a list of the files that have changed, and the file block numbers of those changed files, to inform a content scanning process 160. Further details of an example embodiment of a process for detecting changed files are provided below.

The content scanning process 160 may begin when the content scanner 112 reads 162 file blocks of a changed file from one of the backups 111. The blocks that have been read out 162 may then be analyzed 164. The analyzing 164 may comprise, for example, looking for evidence of the presence of ransomware or other malware, or examining the blocks for other purposes, such as, for example, to identify any PII that may be present. After the analyzing 164, the method 160 may perform a check 166 to determine whether or not there are any remaining changed files that have not yet been read out and analyzed. If not, the method 160 may terminate. If there are remaining files, the method 160 may proceed again to 162. Further details concerning an example embodiment of a content scanning process are provided below.

### B.2 Change file detection

It is noted that not all volumes are comprised of a single disk. A ‘volume’ is a logical concept and has historically been interchangeable with the word ‘disk.’ Today, however, there are disk configurations that comprise multiple disks, such as RAID configurations for example, and referred to as logical volume management (LVMs). As used herein, the term ‘volume’ embraces, but is not limited to, a series of blocks. Blocks may be all the same size and may be referenced by logical blocks numbers (LBA) starting at 0.

Disks may be quite large, and are often partitioned into sections. Disk extents are relative to a partition. In an embodiment, the translation of disk extents to physical blocks within the backup is performed so that the content scanner can read physical blocks without regard for partition scheme, LVM configuration, or file system.

An embodiment operates to determine which files have changed from a backup compared to the previous backup. This process may compare many files and because of that, must be fast and efficient. In an embodiment, this task is performed by producing a unique hash for each file, where the hash is created by hashing the metadata fields of the file, and then sorting the file list by those hashes. Comparing two sorted file lists makes it relatively easy and efficient to find items that have been added or deleted as between two backups.

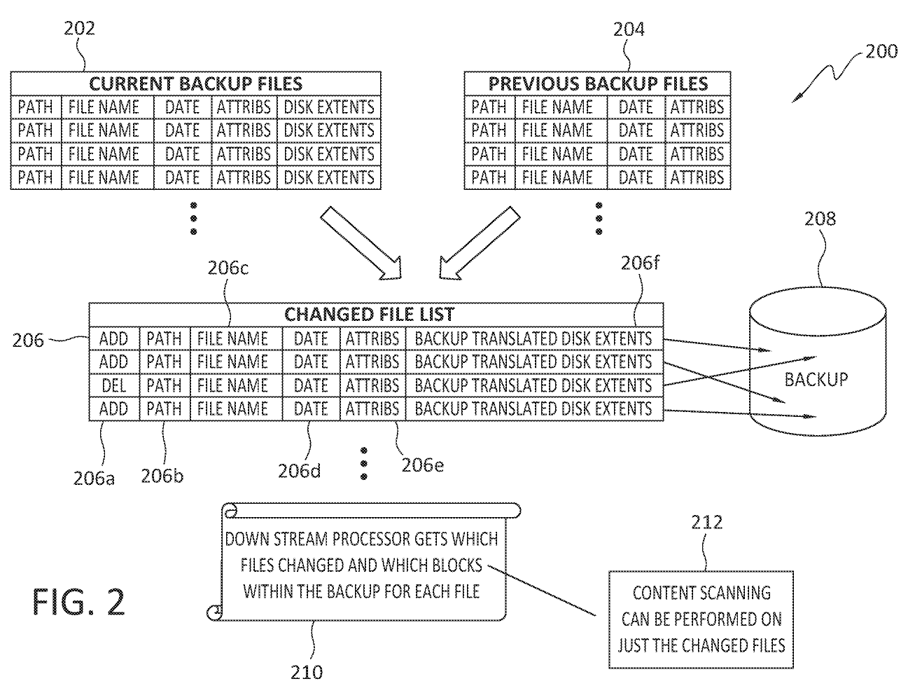

With attention now to FIG. 2, an example schema 200 for identifying changed files is disclosed. As shown an embodiment may compare a list 202 of current backup files, with a list 204 of files from a previous backup which may, or may not, be the immediately preceding backup. The list 202 may comprise disk extents for each of the listed files. The result of this comparison may be a changed file list 206. The changed file list 206 may include various information including, but not limited to, the nature of the operation 206a that was performed concerning a file, the file pathname 206b, the name 206c of the changed file, the date 206d that the file was changed, metadata 206e concerning the changed file, and the disk extents 206f for each of the changed files. As shown, the disk extents 206f may refer to the location of the file in a backup 208 stored on disk.

With continued reference to the example of FIG. 2, a downstream processor 210, such as a content scanner (see FIG. 1), may read out, and scan 212, the blocks for each file that was identified as having changed. In an embodiment, only blocks of changed files are read out and scanned 212, while the blocks of unchanged files are not read out or scanned.

### B.3 Content scanner

In performing a file scanning process, an embodiment may take advantage of the changed file list. In various embodiments, a content scanner may be, for example, a separate stand-alone product, a plug-in, a third party offering, or its functionality may be provided to a customer/client as-as-Service (aaS). Providing a content scanner with a changed file list with translated blocks between two backups a useful part of a process in which only the changes are scanned and analyzed. As noted above, the content scanner needs access to the backup residing on the backup device. This access may require authorization and ‘read’ access rights to the backup in question.

In an embodiment, the scanning of changed files takes place post-backup process. In an embodiment, this content scanning may be embedded in the data protection process itself but may impact the speed and/or effectiveness of the data protection process. On the other hand, performing scanning post-backup enables the backup process to take priority, and scanning to lag the backup process. When backing up many assets simultaneously, this content scanning can appear to be running in parallel to the backup process but will always finish slightly behind the backup completion, depending, for example, on the number of changed files. If there are only a few changed files, the two processes may finish at nearly the same time, while if there are numerous changed files, the content scanning process may finish noticeably behind the backup process.

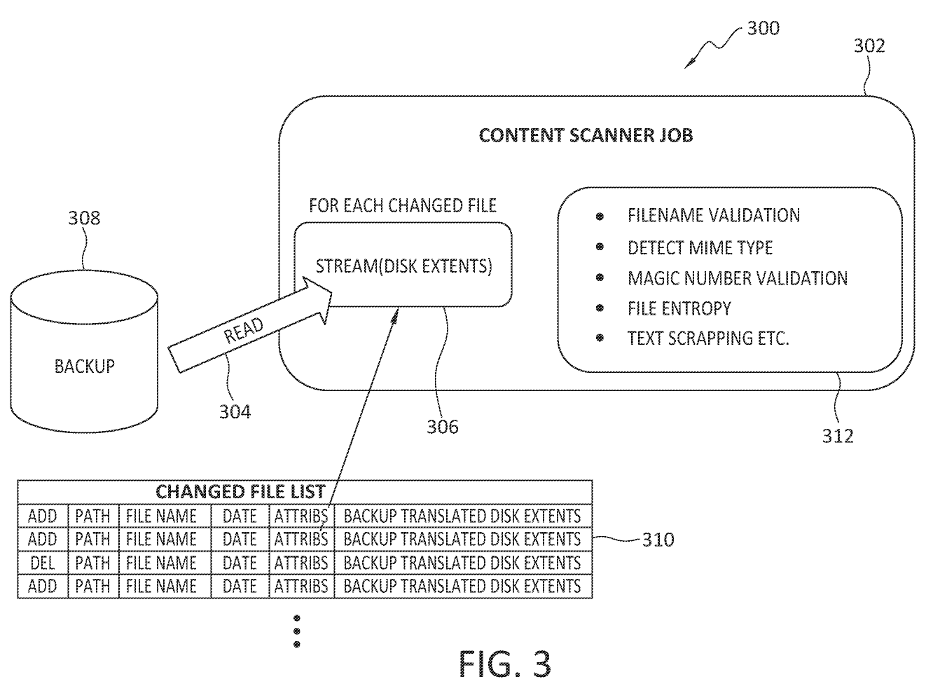

In an embodiment, encapsulating a stream around each file to be scanned allows for different applications to read changed files in a streaming fashion from the backup, without regard for, or the need, to move between different extents. This approach may enable the use of third party tools for content scanning since such tools often work off a file stream. Embodiments may employ a variety of different approaches and techniques for validating content. Some examples of these are discussed below in connection with the example of FIG. 3.

In particular, FIG. 3 discloses an example schema 300, according to one embodiment, for content scanning. As shown, a content scanner job 302, which may scan files on an individual file basis, may receive, or read 304, a stream 306 of disk extents for one or more changed files of a backup 308. The changed files, and their associated disk extents, may be obtained from a changed file list 310. The content scanner job 302 may employ a variety of different techniques for scanning and analyzing content. Some non-limiting examples of such techniques are indicated at 312. The scope of this disclosure is not limited to any particular technique for content scanning or validation.

### C. Further discussion

As disclosed herein, embodiments may comprise various useful features and aspects, although no embodiment is required to possess any of such features or aspects. The following examples are illustrative, but not exhaustive.

An embodiment may implement out-of-band post processing content scanning of just the changes between two backups, which may minimize the problem of certifying a backup. In an embodiment, a relatively simple content scanning job can be added to the data protection process and may operate to detect, in the backed up data, some of the most virulent ransomware strains, such as those which encrypt in place without changing the filename.

In an embodiment, a post processing content scanner may also be extended to incorporate change block tracking if that is available. This approach may enable further validation of actual files that have changed based on the block numbers that have actually been backed up. In this example approach, change block numbers may be run through the disk extents to produce a third file list which could be used during comparison to help identify changed files. This approach would prevent ransomware from avoiding detection when the ransomware operates by keeping the directory intact without changes.

### D. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments. These are presented only by way of example and are not intended to limit the scope of this disclosure or the claims in any way.
Embodiment 1. A method, comprising: receiving a first file catalog for a first backup; comparing a file list of the first file catalog with a file list of a subsequent file catalog for a second backup occurring after the first backup; based on the comparing, identifying as changed files, those files that have changed between the first backup and the second backup; receiving each changed file as a stream; scanning disk extents present in the stream; and based on the scanning, identifying content of interest in one or more of the changed files.
Embodiment 2. The method as recited in any preceding embodiment, wherein the scanning overlaps in time with the second backup.
Embodiment 3. The method as recited in any preceding embodiment, wherein the content of interest indicates a presence of malware in the second backup.
Embodiment 4. The method as recited in any preceding embodiment, wherein only changed files are scanned, and any unchanged files are not scanned.
Embodiment 5. The method as recited in any preceding embodiment, wherein the scanning comprises change block tracking.
Embodiment 6. The method as recited in any preceding embodiment, wherein the scanning comprises identifying physical blocks corresponding to the disk extents.
Embodiment 7. The method as recited in any preceding embodiment, wherein a changed file list is generated that includes a listing of the changed files.
Embodiment 8. The method as recited in any preceding embodiment, wherein the disk extents are identified in the file list of the subsequent file catalog.
Embodiment 9. The method as recited in any preceding embodiment, wherein the content of interest indicates file corruption, file encryption, or file infection.
Embodiment 10. The method as recited in any preceding embodiment, wherein the second backup comprises a backup of multiple assets.
Embodiment 11. A system, comprising hardware and/or software, operable to perform any of the operations, methods, or processes, or any portion of any of these, disclosed herein.
Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

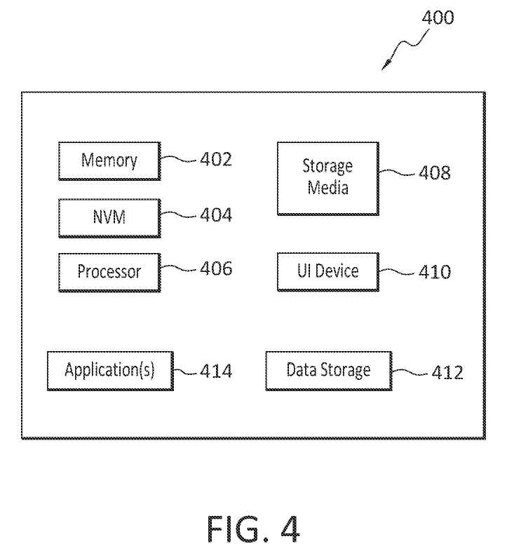

With reference briefly now to FIG. 4, any one or more of the entities disclosed, or implied, by FIGS. 1-3, and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
receiving a first file catalog for a first backup;
comparing a file list of the first file catalog with a file list of a subsequent file catalog for a second backup occurring after the first backup;
based on the comparing, identifying as changed files, those files that have changed between the first backup and the second backup;
receiving each changed file as a stream;
scanning disk extents present in the stream; and
based on the scanning, identifying content of interest in one or more of the changed files.

2. The method as recited in claim 1, wherein the scanning overlaps in time with the second backup.

3. The method as recited in claim 1, wherein the content of interest indicates a presence of malware in the second backup.

4. The method as recited in claim 1, wherein only changed files are scanned, and any unchanged files are not scanned.

5. The method as recited in claim 1, wherein the scanning comprises change block tracking.

6. The method as recited in claim 1, wherein the scanning comprises identifying physical blocks corresponding to the disk extents.

7. The method as recited in claim 1, wherein a changed file list is generated that includes a listing of the changed files.

8. The method as recited in claim 1, wherein the disk extents are identified in the file list of the subsequent file catalog.

9. The method as recited in claim 1, wherein the content of interest indicates file corruption, file encryption, or file infection.

10. The method as recited in claim 1, wherein the second backup comprises a backup of multiple assets.

11. A non-transitory storage medium having stored therein instructions that are executable by one or more hardware processors to perform operations comprising:
receiving a first file catalog for a first backup;
comparing a file list of the first file catalog with a file list of a subsequent file catalog for a second backup occurring after the first backup;
based on the comparing, identifying as changed files, those files that have changed between the first backup and the second backup;
receiving each changed file as a stream;
scanning disk extents present in the stream; and
based on the scanning, identifying content of interest in one or more of the changed files.

12. The non-transitory storage medium as recited in claim 11, wherein the scanning overlaps in time with the second backup.

13. The non-transitory storage medium as recited in claim 11, wherein the content of interest indicates a presence of malware in the second backup.

14. The non-transitory storage medium as recited in claim 11, wherein only changed files are scanned, and any unchanged files are not scanned.

15. The non-transitory storage medium as recited in claim 11, wherein the scanning comprises change block tracking.

16. The non-transitory storage medium as recited in claim 11, wherein the scanning comprises identifying physical blocks corresponding to the disk extents.

17. The non-transitory storage medium as recited in claim 11, wherein a changed file list is generated that includes a listing of the changed files.

18. The non-transitory storage medium as recited in claim 11, wherein the disk extents are identified in the file list of the subsequent file catalog.

19. The non-transitory storage medium as recited in claim 11, wherein the content of interest indicates file corruption, file encryption, or file infection.

20. The non-transitory storage medium as recited in claim 11, wherein the second backup comprises a backup of multiple assets.
